(19) United States
(12) Patent Application Publication
(10) Pub. No.: US 2024/0174252 A1
(43) Pub. Date: May 30, 2024

(54) VEHICULAR AUTOMATED EMISSION SENSING AND ALERT SYSTEM

(71) Applicant: Magna Electronics Inc., Auburn Hills, MI (US)

(72) Inventors: Shrestha Priya, Bihar (IN); Krishnanand Hindoddi, Karnataka (IN); Veeranagouda Salmani, Karnataka (IN)

(21) Appl. No.: 18/508,358

(22) Filed: Nov. 14, 2023

Related U.S. Application Data
(60) Provisional application No. 63/385,085, filed on Nov. 28, 2022.

(51) Int. Cl. B60W 50/14

(52) U.S. Cl. CPC B60W 50/14; B60W 2050/143; B60W 2050/146; B60W 2400/00

(57) ABSTRACT

A vehicular sensing system includes a sensor disposed at a vehicle and operable to capture sensor data representative of exhaust emitted by the vehicle during operation of the vehicle. A data processor processes sensor data captured by the sensor to determine a measured level of a pollutant present in the exhaust emitted by the vehicle. The vehicular sensing system, responsive to processing of sensor data captured by the sensor, determines that the measured level of the pollutant present in the exhaust is greater than a threshold level.

### CROSS REFERENCE TO RELATED APPLICATION

The present application claims the filing benefits of U.S. provisional application Ser. No. 63/385,085, filed Nov. 28, 2022, which is hereby incorporated herein by reference in its entirety.

### FIELD OF THE INVENTION

The present invention relates generally to a sensing system for a vehicle.

### BACKGROUND OF THE INVENTION

Vehicle exhaust emissions are a significant source of pollution that can be harmful to human health and the environment. Over the life of a vehicle, pollution emissions from the vehicle may increase. Furthermore, some jurisdictions employ certification programs that require vehicle inspection and emissions testing for vehicles registered in the jurisdiction. Vehicles that fail the emissions testing (e.g., emissions are measured above a legal limit) are unable to be registered and thus unable to be legally operated. Typically, emissions testing is the responsibility of the vehicle owner and is performed at testing stations or mechanic shops.

### SUMMARY OF THE INVENTION

A vehicular sensing system is configured to measure a current level of pollutants present in the exhaust emissions of a vehicle and communicate with a driver of the vehicle based on the measured level of pollutants. The system may issue an alert to the driver when the measured level of pollutants exceeds a maximum allowed level of pollutants and suggest a corrective action to reduce emission levels. Optionally, the system may generate certification for a vehicle that complies with regulatory emissions standards.

For example, a vehicular sensing system includes a sensor disposed at a vehicle equipped with the vehicular sensing system. The sensor captures sensor data representative of exhaust emitted by the vehicle during operation of the vehicle. An electronic control unit (ECU) includes electronic circuitry and associated software, including a processor for processing sensor data captured by the sensor to determine a measured level of pollutants present in the exhaust emitted by the vehicle. The system, responsive to processing of sensor data captured by the sensor, determines that the measured level of pollutants present in the exhaust is greater than a threshold level of pollutants. Responsive to determining that the measured level of pollutants is greater than the threshold level of pollutants, the system generates an alert to a driver of the vehicle. The generated alert includes an indication that the level of pollutants present in the exhaust is greater than the threshold level of pollutants, and a recommended corrective action.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensing system that includes a sensor configured to capture sensor data representative of exhaust emitted by the vehicle during operation.

### DESCRIPTION OF THE PREFERRED EMBODIMENTS

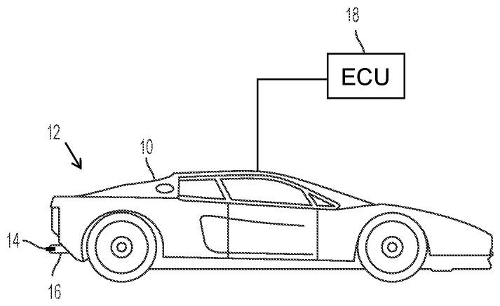

Referring now to the drawings and the illustrative embodiments depicted therein, a vehicle 10 includes a sensing system or emissions sensing system 12 that includes at least one sensor 14 at the vehicle 10 that is configured to measure or detect pollutants emitted during operation of the vehicle 10 (FIG. 1). For example, the sensor 14 may include an air quality sensor disposed in the exhaust system of the vehicle and configured to monitor gases and particulate matter emitted by the vehicle that may be harmful to human health or the environment, such as carbon monoxide, nitrogen oxides, and hydrocarbons. The sensor 14 may be positioned at the tailpipe 16 of the vehicle to measure pollutant levels of exhaust gases exiting the exhaust system of the vehicle. The system 12 includes an electronic control unit (ECU) 18 that includes electronic circuitry and associated software, including a processor configured to process sensor data captured by the sensor 14. The ECU 18 may be disposed at any suitable position at the vehicle, such that the data transfer or signal communication from the sensor 14 to the ECU 18 may comprise any suitable data or communication link, such as a vehicle network bus or the like of the equipped vehicle. Optionally, the processor may be disposed remote from the vehicle 10, such as at a remote server, where the vehicle 10 is equipped with a wireless communication module (such as a transmitting and receiving antenna) and the system 12 wirelessly communicates captured sensor data to the processor via the wireless communication module.

As the vehicle 10 is operated (i.e., when the combustion engine or other propulsion or drive systems of the vehicle are operated), the sensor 14 captures sensor data representative of pollution levels present in the vehicle exhaust. The system 12 processes the captured sensor data at the processor of the ECU 18 to determine current emissions levels for the vehicle. For example, the system 12 may determine a current level of greenhouse gases being emitted by the vehicle. The system 12 may determine any suitable metric related to vehicle emissions, such as a total measure of pollutants emitted during a time period (e.g., during a driving session or over the course of a day, week, month, year, or the like) or an average measure of pollutants emitted (e.g., average pollutants emitted per second, per minute, per hour, per mile driven, per gallon of fuel consumed, or the like). Furthermore, the system 12 may store determined emissions levels and captured sensor data in memory storage, such as for historical analysis of emissions levels, advanced processing of the captured sensor data, and the like. For example, the system 12 may compare measured pollutant levels to a historical average pollutant level for the vehicle to determine whether current pollutants levels are high enough to trigger an alert. The system 12 may automatically check levels of emissions from the vehicle (e.g., continuously as the vehicle is driven or at regular time intervals) or the system may capture and process sensor data in response to a user input, such as an input in the cabin of the vehicle that is actuatable by the driver to initiate a diagnostic check of the vehicle emission levels.

The system 12 may communicate or display messages or images or alerts to the driver based on the determined emissions levels. For example, the vehicle 10 may include a display device in the cabin of the vehicle and the system may display messages at the display device for viewing by the driver. The display device may be disposed at any suitable position for viewing by the driver, such as at or incorporated in the interior rearview mirror assembly or center console or gauge cluster of the vehicle. Optionally, the system 12 may communicate signals to a mobile device of the driver so that the driver may view messages related to the vehicle emissions at a display screen of their mobile device.

The system 12 may issue an alert or signal or message to the driver of the vehicle responsive to determining that the emissions level of the vehicle is above a threshold emissions level. For example, the threshold emissions level may be determined based on historical average emissions level for the vehicle (such that the alert is issued when emissions are higher than normal for the vehicle) or the threshold emissions level may be predetermined, such as based on a maximum allowable emissions level for one or more pollutants.

When emissions levels are determined to be high, such as when emissions levels exceed the threshold emissions levels, the system 12 may communicate a message to the driver suggesting corrective action. For example, the message may suggest that the driver perform maintenance on the vehicle or take the vehicle to a mechanic or dealership for repairs. The system 12 may also suggest the driver alter driving habits (e.g., to accelerate less severely) or adjust a type of fuel used (e.g., to use a higher octane fuel or fuel additive) to reduce emissions.

In some examples, when emission levels are determined to be greater than the threshold emissions levels, the system 12 may trigger a corrective action of the vehicle. For example, the system 12 may adjust a driving mode of the vehicle (e.g., from a sport driving mode to a default or regular driving mode or an eco driving mode) or adjust usage of a propulsion system of the vehicle (e.g., adjust a hybrid vehicle from operating in a gasoline-only propulsion mode to operating in a hybrid or electric-only propulsion mode, initiate cylinder deactivation, and the like). Optionally, the corrective action may adjust operation of a heating, ventilation, and air conditioning (HVAC) system of the vehicle, such as to shut off or reduce usage of the HVAC system to reduce emissions. When the vehicle is stationary and the system determines that the emissions levels are greater than the threshold emissions levels, the system may control operation of a start-stop system of the vehicle to shut off the combustion engine of the vehicle and reduce the time that the engine idles while the vehicle is stopped.

Furthermore, the system 12 may generate messages for the driver to support driving habits that lower emissions levels. For example, if emissions levels are lower than average or below a second, lower emissions threshold, the system 12 may display a message indicating the lower emissions and corresponding driving behaviors or factors.

Moreover, if the vehicle is operated in a jurisdiction that requires emissions testing and certification for authorized operation of the vehicle, the system 12 may monitor an expiration date of emissions certification and issue a warning to the driver to update the inspection certification for the vehicle. If approved, the emission levels determined by the system 12 may be used to certify the vehicle. That is, the system 12 may be configured to generate pollution or emissions certifications so that the vehicle 10 may comply with local regulations.

Emissions data may be captured using any suitable sensor 14. For example, the sensor may comprise a volatile organic compound sensor that detects volatile chemicals and other pollutants in the vehicle exhaust, an ionization detector, a photoelectric detector, or a non-dispersive infrared sensor configured to determine presence and concentrations of different pollutants in the air based on the absorption of different wavelengths of light passed through an air sample. The system may include one or more sensors configured to determine presence and/or concentration of one or more pollutants or particulates present in the exhaust, such as carbon monoxide, sulfur dioxide, nitrogen oxides, formaldehyde, hydrocarbons, and dust or soot.

Further, for different pollutants sensed by the system, the system may have different sensitivity levels or threshold levels for triggering the alert to the driver. For example, the system may have a first threshold concentration level for carbon monoxide or nitrogen oxide or other gases sensed by the system and a different second threshold concentration level for dust or soot or other particulates sensed by the system.

The vehicle may operate under power of any suitable propulsion system. For example, the vehicle may include a combustion engine (e.g., a gasoline or diesel fuel powered engine). Optionally, the vehicle may include a hybrid propulsion system where the vehicle includes a combustion engine and an electric powered motor that is operated via power from a battery system of the equipped vehicle. For hybrid vehicles, the emissions sensing system 12 may capture emissions data and, based on the captured emissions data, determine a condition of the hybrid system, such as an efficiency of the system (e.g., a ratio of combustion operation measured against electric operation). Optionally, the emissions sensing system 12 may determine, based on the emissions data, that the vehicle propulsions system requires maintenance (e.g., if the combustion engine is operating at a speed or vehicle condition that would normally require operation of only the electric propulsion system). The emissions sensing system 12 may similarly be configured to capture emissions data for vehicles having other propulsion systems, such as fully electric vehicles (e.g., to determine emissions from a heating, ventilation, and air conditioning system of the vehicle) and hydrogen powered vehicles.

Thus, the system provides a built-in automatic emissions detection and warning certification system. The system automatically checks the level of emissions from the vehicle. It warns users and suggests the user take corrective actions if emissions are high, such as via a mobile application or multimedia dashboard in the vehicle. These warnings may be compared to standards of the pollution norms. A user may generate a certificate of emission over their mobile phone.

Emission data is captured from the exhaust, such as via a miniature emission detection sensor installed on the exhaust and continuously monitoring emissions. Other pollution measuring related sensors may be used. The captured emission data is compared with prescribed norms over a period of time. The status of emissions may be updated in the mobile app and the vehicle dashboard memory to reflect the data at any given point in time. The user may receive a warning if the emissions are exceeding the prescribed limits for a threshold period of time.

The user may access and view the level of emissions and warnings on the dashboard, such as via the vehicle display screen or the user's mobile device. The system may provide a warning of expiration of emissions certification or variation of vehicle emissions from the existing pollution norms.

Thus, the system provides more control to the user and visibility in to emission related issues and enables the user to take corrective action as soon as an emission warning is generated. Furthermore, the system may enable the user to generate certifications for emission levels instead of requiring that the user bring the vehicle to an authorized pollution testing center.

The system includes a processor operable to process data captured by the sensors. For example, the processor may comprise a processing chip selected from the EYEQ family of processing chips available from Mobileye Vision Technologies Ltd. of Jerusalem, Israel.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or a 4G or 5G broadband cellular network) technology provides for communication between vehicles and/or infrastructure based on information provided by one or more vehicles and/or information provided by a remote server or the like. Such vehicle communication systems may utilize aspects of the systems described in U.S. Pat. Nos. 10,819,943; 9,555,736; 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
a sensor disposed at a vehicle equipped with the vehicular sensing system, wherein the sensor is operable to capture sensor data representative of exhaust emitted by the vehicle during operation of the vehicle;
an electronic control unit (ECU) comprising electronic circuitry and associated software, wherein the electronic circuitry comprises a data processor for processing sensor data captured by the sensor to determine a measured level of a pollutant present in the exhaust emitted by the vehicle; and
wherein the vehicular sensing system, responsive to processing at the ECU of sensor data captured by the sensor, determines that the measured level of the pollutant present in the exhaust is greater than a threshold level.

2. The vehicular sensing system of claim 1, wherein the vehicular sensing system, responsive to determination that the measured level of the pollutant present in the exhaust is greater than the threshold level, generates an alert to a driver of the vehicle.

3. The vehicular sensing system of claim 2, wherein the generated alert comprises an indication that the level of the pollutant present in the exhaust is greater than the threshold level.

4. The vehicular sensing system of claim 2, wherein the generated alert comprises a corrective action.

5. The vehicular sensing system of claim 4, wherein the corrective action comprises a message indicating at least one selected from the group consisting of (i) that the vehicle requires maintenance, (ii) that the driver should alter driving habits, and (iii) that a fuel of the vehicle should be adjusted.

6. The vehicular sensing system of claim 2, wherein the vehicle comprises a display device, and wherein the generated alert comprises a graphical display displayed at the display device and including at least one selected from the group consisting of (i) an indication that the level of the pollutant present in the exhaust is greater than the threshold level and (ii) a corrective action.

7. The vehicular sensing system of claim 2, wherein the generated alert comprises an audio signal.

8. The vehicular sensing system of claim 2, wherein the vehicular sensing system wirelessly transmits a signal based on the generated alert to a mobile device of the driver.

9. The vehicular sensing system of claim 1, wherein the vehicular sensing system, responsive to determination that the measured level of the pollutant present in the exhaust is greater than the threshold level, initiates a corrective action.

10. The vehicular sensing system of claim 9, wherein the correction action comprises (i) adjusting a drive mode of the vehicle, (ii) adjusting operation of a heating, ventilation, and air conditioning (HVAC) system of the vehicle and (iii) adjusting operation of a propulsion system of the vehicle.

11. The vehicular sensing system of claim 1, wherein the measured level of the pollutant present in the exhaust comprises a total amount of the pollutant present in the exhaust during a period of time.

12. The vehicular sensing system of claim 1, wherein the measured level of the pollutant present in the exhaust comprises an average amount of the pollutant present in the exhaust during a period of time.

13. The vehicular sensing system of claim 1, wherein the vehicular sensing system stores the measured level of the pollutant in memory storage as historical pollutant data.

14. The vehicular sensing system of claim 13, wherein the threshold level is determined based at least in part on the historical pollutant data.

15. The vehicular sensing system of claim 1, wherein the vehicular sensing system, based on an expiration date of emissions certification for the vehicle, generates a certification alert to the driver to renew emissions certification for the vehicle.

16. The vehicular sensing system of claim 1, wherein the threshold level is based at least in part on a maximum allowed level of the pollutant for the vehicle.

17. The vehicular sensing system of claim 16, wherein the threshold level is the maximum allowed level of pollutants for the vehicle.

18. The vehicular sensing system of claim 16, wherein the vehicular sensing system, based on the measured level of the pollutant present in the exhaust being less than the threshold level, determines that the vehicle is compliant with the maximum allowed level of the pollutant.

19. The vehicular sensing system of claim 18, wherein, based on the vehicular sensing system determining that the vehicle is compliant with the maximum allowed level of the pollutant, an emissions certification is issued for the vehicle.

20. The vehicular sensing system of claim 1, wherein the vehicle comprises an internal combustion engine.

21. The vehicular sensing system of claim 1, wherein the vehicle comprises a hybrid propulsion system that includes an electrically powered motor and an internal combustion engine.

22. A vehicular sensing system, the vehicular sensing system comprising:
a sensor disposed at a vehicle equipped with the vehicular sensing system, wherein the sensor is operable to capture sensor data representative of exhaust emitted by the vehicle during operation of the vehicle;
wherein the vehicle comprises an internal combustion engine;
an electronic control unit (ECU) comprising electronic circuitry and associated software, wherein the electronic circuitry comprises a data processor for processing sensor data captured by the sensor to determine a measured level of a pollutant present in the exhaust emitted by the vehicle;
wherein the vehicular sensing system, responsive to processing at the ECU of sensor data captured by the sensor, determines that the measured level of the pollutant present in the exhaust is greater than a threshold level; and
wherein the vehicular sensing system, responsive to determination that the measured level of the pollutant present in the exhaust is greater than the threshold level, generates an alert to a driver of the vehicle, and wherein the generated alert comprises an indication that the level of the pollutant present in the exhaust is greater than the threshold level.

23. The vehicular sensing system of claim 22, wherein the vehicle comprises a display device, and wherein the generated alert comprises a graphical display displayed at the display device and including (i) the indication that the level of the pollutant present in the exhaust is greater than the threshold level and (ii) a corrective action.

24. The vehicular sensing system of claim 22, wherein the vehicular sensing system, responsive to determination that the measured level of the pollutant present in the exhaust is greater than the threshold level, initiates a corrective action.

25. The vehicular sensing system of claim 24, wherein the correction action comprises (i) adjusting a drive mode of the vehicle, (ii) adjusting operation of a heating, ventilation, and air conditioning (HVAC) system of the vehicle and (iii) adjusting operation of a propulsion system of the vehicle.

26. The vehicular sensing system of claim 22, wherein the measured level of the pollutant present in the exhaust comprises one selected from the group consisting of (i) a total amount of the pollutant present in the exhaust during a period of time and (ii) an average amount of the pollutant present in the exhaust during a period of time.

27. The vehicular sensing system of claim 22, wherein the vehicle comprises a hybrid propulsion system that includes an electrically powered motor and the internal combustion engine.

28. A vehicular sensing system, the vehicular sensing system comprising:
a sensor disposed at a vehicle equipped with the vehicular sensing system, wherein the sensor is operable to capture sensor data representative of emissions emitted by the vehicle during operation of the vehicle;
wherein the vehicle comprises a hybrid propulsion system that includes an electrically powered motor and an internal combustion engine;
an electronic control unit (ECU) comprising electronic circuitry and associated software, wherein the electronic circuitry comprises a data processor for processing sensor data captured by the sensor to determine a measured level of a pollutant present in the emissions emitted by the vehicle;
wherein the vehicular sensing system, responsive to processing at the ECU of sensor data captured by the sensor, determines that the measured level of the pollutant present in the emissions is greater than a threshold level;
wherein the threshold level is based at least in part on a maximum allowed level of the pollutant for the vehicle; and
wherein the vehicular sensing system, based on the measured level of the pollutant present in the emissions being less than the threshold level, determines that the vehicle is compliant with the maximum allowed level of the pollutant.

29. The vehicular sensing system of claim 28, wherein the vehicular sensing system, responsive to determination that the measured level of the pollutant present in the emissions is greater than the threshold level, generates an alert to a driver of the vehicle.

30. The vehicular sensing system of claim 29, wherein the vehicle comprises a display device, and wherein the generated alert comprises a graphical display displayed at the display device and including at least one selected from the group consisting of (i) an indication that the level of the pollutant present in the emissions is greater than the threshold level and (ii) a corrective action.

31. The vehicular sensing system of claim 29, wherein the measured level of the pollutant present in the emissions comprises one selected from the group consisting of (i) a total amount of the pollutant present in the emissions during a period of time and (ii) an average amount of the pollutant present in the emissions during a period of time.

32. The vehicular sensing system of claim 29, wherein the vehicular sensing system, based on an expiration date of emissions certification for the vehicle, generates a certification alert to the driver to renew emissions certification for the vehicle.

33. The vehicular sensing system of claim 32, wherein the threshold level is the maximum allowed level of pollutants for the vehicle.

34. The vehicular sensing system of claim 28, wherein, based on the vehicular sensing system determining that the vehicle is compliant with the maximum allowed level of the pollutant, an emissions certification is issued for the vehicle.
